(19) United States
(12) Patent Application Publication
(10) Pub. No.: US 2007/0256846 A1
(43) Pub. Date: Nov. 8, 2007

(54) Gibbs' lawn mower attachment assembly kit

(76) Inventor: Garfield L. Gibbs, Fayetteville, NC (US)

Correspondence Address: Garfield L. Gibbs, 5603 Sack Street, Fayetteville, NC, 28303-2855, US

(21) Appl. No.: 11/784,960

(22) Filed: Apr. 10, 2007

Related U.S. Application Data
(60) Provisional application No. 60/797,194, filed on May 3, 2006.

(51) Int. Cl. A01B 63/00

(52) U.S. Cl. 172/452

(57) ABSTRACT

A device is provided for attachment of implements and tools to a zero-radius turn lawnmower or similar vehicle, comprising a rigid vertical frame including a topside and a bottomside and means for coupling to the lawnmower or vehicle; a rigid horizontal frame including a rear side, pivotally coupled to the bottomside of vertical frame, and a front side furnished with means for fixing the implements or tools; a winch mounted on the topside of vertical frame; a controllable motor associated with and capable to drive the winch; a cable means including a lower and an upper end, wherein the lower end fixed substantially in the middle of the front side of horizontal frame, and the upper end fixed to the winch so that the cable means capable to be wound on or off the winch, whereby lifting the horizontal frame into a storage position or lowering into an operation position.

### CROSS REFERENCES TO RELATED APPLICATIONS

This application claims the benefit according to 35 U.S.C. 119(e) of a U.S. provisional patent application Ser. No. 60/797,194, filed on May 3, 2006, the disclosure of which is incorporated herein in its entirety by reference.

### TECHNICAL FIELD

The present invention relates to gardening, landscaping, and snow-removing equipment, particularly to hitching or coupler equipment facilitating attachment of tools and implements, and capable to be used in conjunction with zero-radius turn lawn mowers, riding mowers, and similar vehicles.

### BACKGROUND OF THE INVENTION

Prior art describes several types of hitches or couplers for attaching implements and tools to working machines. Particularly, U.S. Pat. No. 5,346,018 teaches a “three-point hitch assembly that attaches to the front end of a truck or pickup and supports at three points a plurality of implements or tools. It has a belt-driven power take-off for rotary tools that is controlled by an electric clutch and driven by a pulley attached below the truck engine pulley. A hydraulic lift cylinder raises and lowers the hitch and implement or tool, which by the hitch parallelogram form maintains the implements in a vertical orientation. The lift cylinder hydraulic pressure is supplied by connections to the truck power steering system via electrically controlled solenoid valves.” Therefore, the device has a limitation of being dependent on the truck power steering system.

A “quick attach implement coupler” is described in U.S. Pat. No. 5,082,065. A “snow blower adapter . . . ” is taught in U.S. Pat. No. 4,104,812 “ . . . for mounting on a powered lawn mower including a housing to receive snow therein and chute means in cooperation with conveyor means to discharge snow from the housing, means to drive the conveyor means including a transmission and a clutch to operatively engage and disengage the transmission from the lawn mower, including a pair of elongate arms adapted to be releasably mounted on the lawn mower.” Both the above-mentioned devices are costly, complicated to manufacture, made of a multitude of heavy parts, and need qualified assemblers and maintainers.

U.S. Pat. No. 6,003,614 discloses a hitch assembly for a tractor for providing oscillation about a horizontal axis and articulation. In particular it notes: “ . . . an additional and very important advantage of the tree-point hitch has been the ability to employ the rotary power take-off shaft typically found on many tractors to power implements while mounted on the standard three-point hitch.”

It further explains: “While the three-point hitch . . . has been found to be acceptable in the past, it has been discovered to be less suitable in its application to articulated tractors and to track-type tractors. A major cause of this unsuitability is the fact that both articulated and track-type tractors tend to require an increased amount of horizontal articulation during their steering operations.” It refers not only to the mentioned types of tractors, but to other zero-radius turn machines, such as several known types of mowers.

On the other hand, U.S. Pat. No. 6,003,614 teaches: “A power-take-off shaft extends through said center of the fixed trunnion supporting the hitch . . . to permit simultaneous connection of the implement with the hitch and the power-take-off shaft for transmitting rotary power to the implement.” The device is a costly and complicated mechanism essentially for connecting to a tractor.

Another example of adaptation means for lawn and garden hitching is described in a publication on http://www.kunzeng.com/hitchpage.htm (retrieved on Mar. 28, 2006) that teaches how to hitch a machine called “AcrEase” to a vehicle. It does not provide details on the machine itself.

### BRIEF SUMMARY OF THE INVENTION

The aforesaid and many other devices do not presently provide a simple means for attachment and detachment of landscaping and gardening tools or implements, so that such means would be easily usable by an average user. Some zero-radius turn lawn mowers do not feature the ability to accept an attachment. Many landscapers and yard workers use this type of mower but must change tools if attachments do not fit or are not available. The present invention allows increasing work capabilities and decreasing time spent when performing several yard or garden treatment tasks. The invention also allows moving and lifting heavy items.

Gibbs' Lawn Mower Attachment Assembly Kit (the inventive device) is intended for utilization preferably on a zero-radius turn lawn mower needed for residential or commercial use. One embodiment of the inventive device is associated with a remote control; others may be used with manual control. The device enables the use of gardening, landscaping, snow-removing implements or tools, such as a snowplow, aerator, and dethacher that are easily interchangeable, i.e. attachable and detachable. Other implements for completion of variety of jobs can also be attached to and detached from the device, provided they are furnished with simple brackets for coupling to the inventive device. A unique feature of the invention is incorporating a winch driven by a motor, which allows not only positioning the tool at a required angle, but also will come in handy when the need for heavy moving or lifting arises. After the job is done, the winch permits to fold the device so that it occupies substantially less space.

### BRIEF DESCRIPTION OF DRAWINGS

FIG. 1 illustrates an isometric view of a preferred embodiment of the inventive device with adjoining units of a lawnmower or a vehicle.

FIG. 2 illustrates an isometric view of a preferred embodiment of the inventive device in an unfolded position without an attached tool.

FIG. 3 illustrates a dethacher for “combing” the grass attachable to the inventive device.

FIG. 4 illustrates an isometric view of an aerator attachable to the inventive device.

FIG. 5 illustrates an isometric view of a snowplow attachable to the inventive device.

Similar reference numerals on the drawings generally refer to the same or similar elements on different figures. A newly introduced numeral in the description is enclosed into parentheses.

### A SAMPLE PREFERRED EMBODIMENT OF THE PRESENT INVENTION

While the invention may be susceptible to embodiment in different forms, there is shown in the drawings, and will be described in detail herein, a specific embodiment of the present invention, with the understanding that the present disclosure is to be considered an exemplification of the principles of the invention, and is not intended to limit the invention to that as illustrated and described herein.

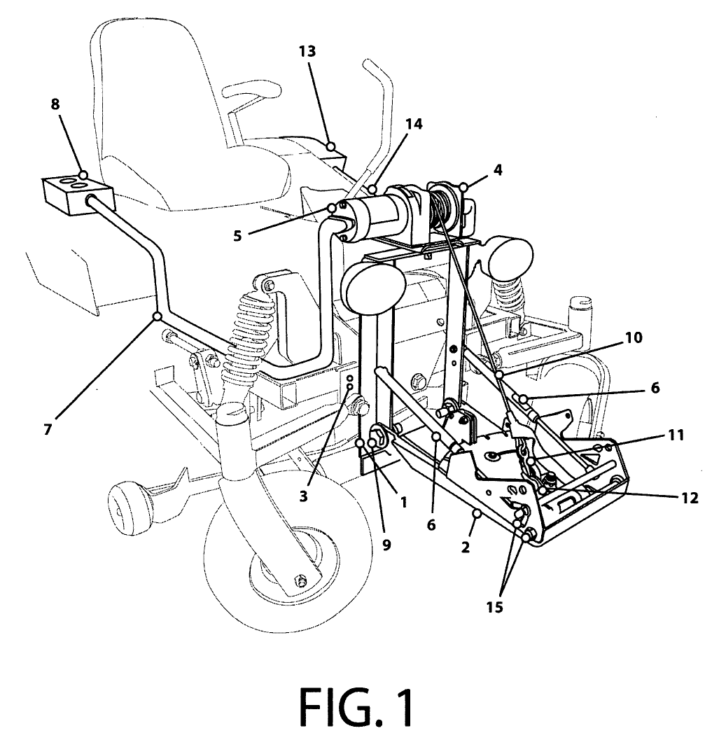

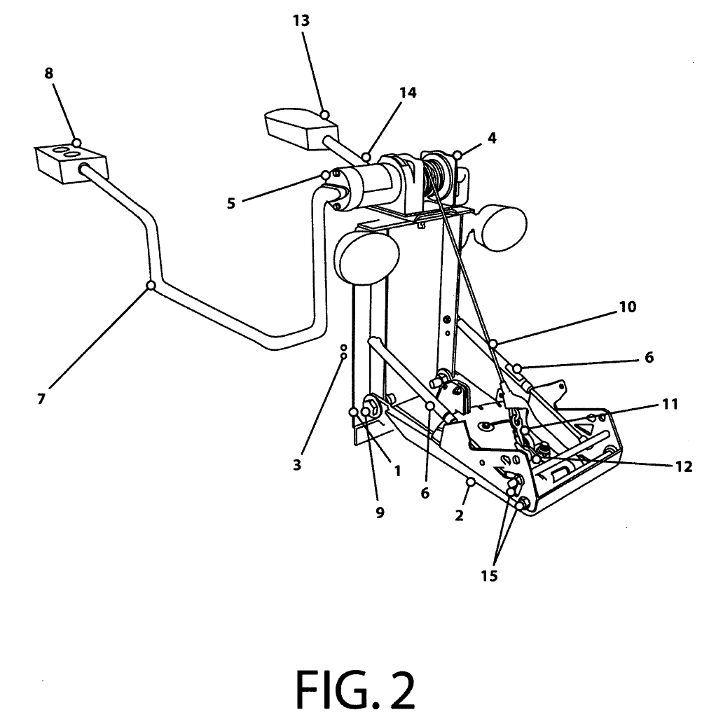

A preferred embodiment of the present invention is illustrated on FIGS. 1, 2. The inventive device comprises a predeterminedly rigid vertical frame (1) having brackets (3) for attachment to a mower or another vehicle. The frame 1 has a topside and a bottomside.

The device comprises a predeterminedly rigid horizontal frame (2), with its rear side pivotally coupled to the bottomside of vertical frame 1 with bolts (9). A front side of the horizontal frame 2 is furnished with a cable attachment means (11) mounted substantially in the middle of the front side. Two support brackets (12) are mounted at the ends of the front side of frame 2 as shown on FIGS. 1, 2. Two longitudinal shocks (6) can be optionally mounted at a predetermined angle attached with their upper ends at a middle region of the vertical frame 1 and with their lower ends to the support brackets 12. Bolts (15) are mounted to the support brackets 12, and serve for securing the attached tool or implement.

The device comprises a winch (4) mounted on the topside of frame 1. The winch 4 is driven by a motor (5), preferably an electric engine powered from a battery (13) installed on the mower, to which the inventive device is attached. The motor 5 is preferably disposed on the topside of frame 1, adjacently to the winch 4, and its rotation is transmitted to the winch 4 through a shaft (not shown in the drawings) extending substantially parallel to the topside of the vertical frame 1. In other embodiments, another type of motor or power source can be implemented.

In the preferred embodiment, the inventive device comprises a remote control device (8) electrically connected to the motor 5 by a wire cord (7). The cord 7 is connected to the motor 5, which connection is preferably performed in an extension compartment (not illustrated) beside the motor. The motor 5 connects to the battery 13 with another wire cord (14). In other embodiments a wireless remote control can be utilized instead. Optionally, a lever (not illustrated) can be arranged on the aforesaid shaft at the end opposite to the end on which the motor 5 is situated. The lever can be used for manual operation of the winch 4, perhaps in association with another mechanism.

The device comprises a cable (10) of a predetermined strength, depicted on FIGS. 1, 2. One (upper) end of the cable 10 is secured to the winch 4, and the other (lower) end is tied to the cable attachment means 11.

Thusly, the inventive device has a motorized remote capability, can be easily attached to the front of the mower by a predetermined method. It also includes a horizontal frame having the capability to lift and lower while being regulated by an electric remote control device, whereby lifting the horizontal frame into a storage position or lowering into an operation position. Necessary tools or implements can be removably and interchangeably attached to the horizontal frame. The following are some examples of such tools or implements reflected on the figures enumerated below.

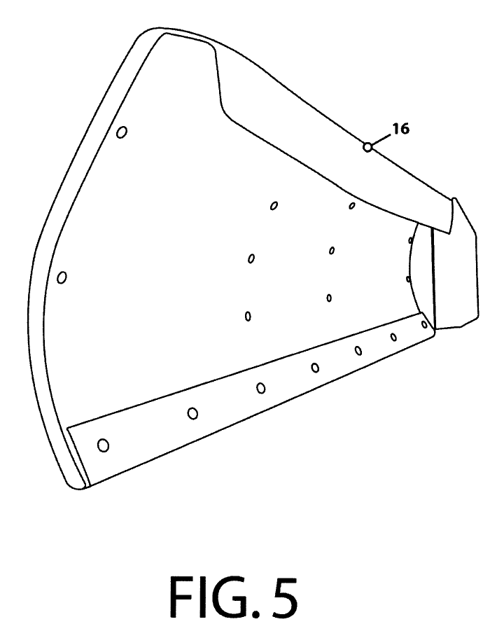

FIG. 5 illustrates a snowplow (16) attachable to the support brackets 12.

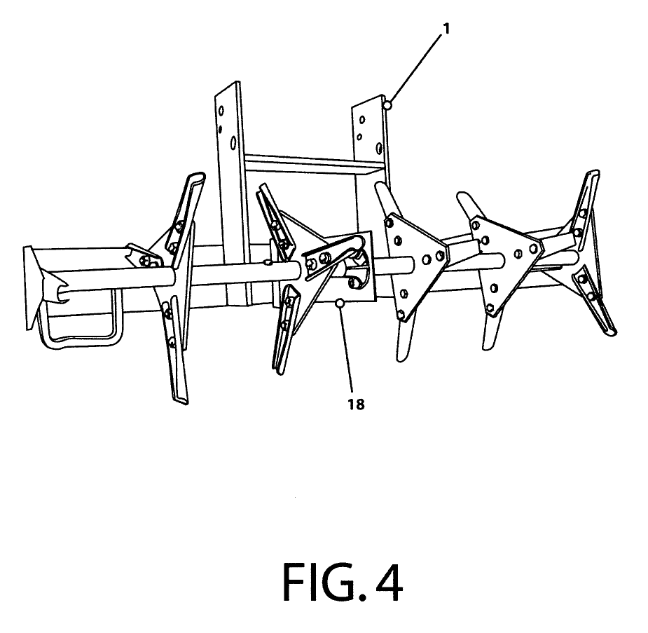

FIG. 4 shows an aerator (18) used to “blow off” the cut lawn grass or other debris. The aerator is attached to the support brackets 12.

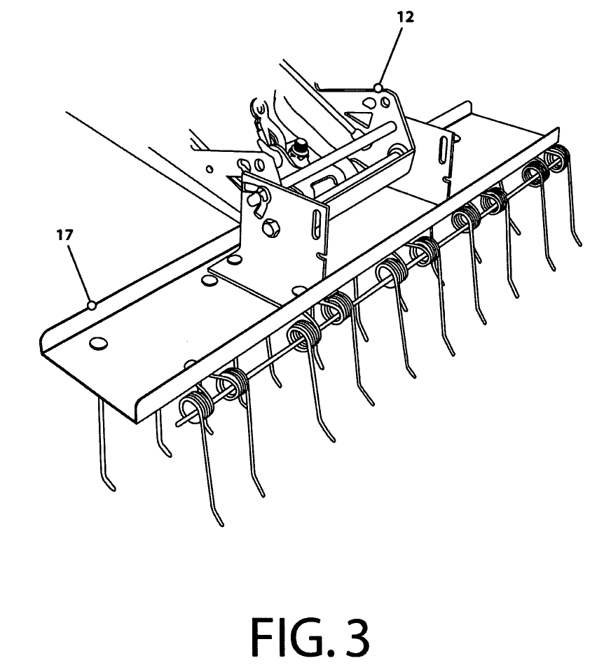

FIG. 3 depicts a dethacher (17) coupled to the support brackets 12. The dethacher is used to “comb” the lawn grass.

The winch 4 can be also be used during landscaping to root out a tree stump (not illustrated) tied to the device by the cable 12. Other loading and unloading works can be performed with deployment of the inventive device.

An example of operation of the above described embodiment, depicted on FIGS. 1, 2, follows.

The brackets 3 of vertical frame 1 are coupled to the mower. In a storage position, the horizontal frame 2 is preferably lifted by the winch 4 via the cable 10, so that the inventive device is in the folded state. The user, riding the mower, presses respective buttons on the remote control device 8, subsequently causing the cable 10 to unwind, and then the front end of the horizontal frame 2 is lowered until it reaches a certain (operation) position desired by the user. An insignificant resistance can be absorbed by the shocks 10. If the tool (implement) to be attached to the device is expected to encounter a significant resistance, e.g. during heavy snow removal, the frame 2 should be lowered to its lowest position (at a 90.degree angle or even more). When the job is finished, the user, pressing a corresponding button, can lift the frame 2 back to its storage position, thereby folding the inventive device.

Those skilled in the art will appreciate that the conception, upon which this disclosure is based, may readily be utilized as a basis for the designing of other structures methods and systems for carrying out several purposes of the present invention. It is therefore important that the claims be regarded as including such equivalent constructions insofar as they do not depart from the spirit and scope of the present invention. As opposed to the claims, the foregoing abstract is neither intended to define the invention of the instant application, which is measured by the claims, nor is it intended to be limiting as to the scope of the invention in any way.

I claim:

1. A device for attachment of gardening, landscaping, snow-removing and other similar implements and tools to a zero-radius turn lawn mower or a similar vehicle, said device comprising:
a predeterminedly rigid vertical frame including a top side and a bottom side and having a means for coupling to said mower or vehicle;
a predeterminedly rigid horizontal frame including a rear side, pivotally coupled to the bottomside of said vertical frame, and a front side furnished with means for fixing the implements or tools;
a winch mounted on the topside of said vertical frame;
a controllable motor means associated substantially with said winch so that capable to drive the winch; and
a cable means including a lower end and an upper end, wherein the lower end fixed substantially in the middle of the front side of said horizontal frame, and the upper end fixed to said winch so that the cable means capable to be wound on and off the winch, whereby lifting the horizontal frame into a storage position or lowering into an operation position.
